(19) United States
(12) Patent Application Publication
(10) Pub. No.: US 2026/0121415 A1
(43) Pub. Date: Apr. 30, 2026

(54) ENERGY STORAGE AND SUPPLY TO ELECTRICAL GRID

(71) Applicant: Power Research and Development Pty Ltd, Fremantle (AU)

(72) Inventor: Colin STONEHOUSE, Fremantle (AU)

(21) Appl. No.: 19/116,780

(22) PCT Filed: Sep. 26, 2023
(86) PCT No.: PCT/AU2023/050929

§ 371 Date: Mar. 28, 2025

(30) Foreign Application Priority Data
Sep. 28, 2022 (AU) 2022902811

(51) Int. Cl. H02J 3/32; H02J 3/38; H02J 15/30; H02J 101/24

(52) U.S. Cl. CPC H02J 3/32; H02J 3/381; H02J 15/30; H02J 2101/24

(57) ABSTRACT

An energy storage and supply system for supplementing a mains grid includes a photovoltaic array to generate electricity, a pumped hydraulic energy store and a battery energy storage system (BESS). The pumped hydraulic energy store and the BESS are connected to a common DC bus, which in turn is connected to an inverter to supply power to the mains grid. If the local area is disconnected from the mains grid, the arrangement allows the BESS to instantaneously supply local power while the pumped hydraulic energy store is brought online.

### FIELD OF THE INVENTION

The present invention relates to the storage of energy, such as electrical energy sourced from renewable sources, and the supply of that energy to an electrical grid when required.

### BACKGROUND TO THE INVENTION

The transition of electrical generating capacity from fossil fuel based generation to renewable generation raises many challenges, including the challenge of stability to an electrical grid.

Most renewable sources of energy generation are inherently intermittent, with solar energy, wind energy, and tidal and wave power all being highly variable based on the time of day, the season of the year, and the current weather conditions. Large turbines such as those used to produce electricity for an urban environment are ill-equipped to rapidly change their power output due to changing weather circumstances.

It is considered that battery storage of electricity may be able to at least partially ameliorate this problem. In theory, a sufficiently large battery and a sufficiently large renewable energy source could combine to serve as a reliable supply of electricity which can be immediately available to the grid at all times. Currently, the size and cost of a sufficiently large battery to provide meaningful support to a power grid is often prohibitive.

The present invention seeks to propose a means both of storing excess energy produced by renewable sources and of providing that energy to the electrical grid in a cost-effective manner. The present invention is considered to have particular application in load smoothing, and in adding capacity at a periphery of the electrical grid.

In recent years a number of Battery Energy Storage Systems (BESS) have entered into use. These systems are often used in conjunction with renewable energy generation to store excess energy generated (for instance, excess solar energy generated during the middle of the day) and to use this stored energy when the rate of generation falls (for instance, during the evening).

One such system is disclosed in U.S. Pat. No. 11,641,177. This patent describes a system having a number of renewable energy generators, each of which is associated with an inverter and a transformer to allow connection to the electrical grid. The system also has a number of energy storage devices, each of which is similarly associated with an inverter and a transformer. The system includes a controller which is programmed to predict energy generation, energy demand, and battery state of charge and to control the flow of energy accordingly.

Such a system is limited in its ability to manage sudden changes in the electrical demand, for instance sudden disconnection from the electrical grid.

### SUMMARY OF THE INVENTION

According to one aspect of the present invention there is provided an energy storage and supply system including:
a renewable energy source arranged to generate electricity;
a first energy storage means arranged to receive electrical energy and to convert that energy to mechanical potential energy; and
a battery energy storage system (BESS) arranged to receive and store electrical energy;
wherein the first energy storage means includes an electricity generating means arranged to convert mechanical potential energy to electrical energy;
the electricity generating means of the first energy storage means and the BESS both being connected to a common DC bus;
the DC bus being connected to an output inverter;
the output inverter being arranged to supply AC electricity to an electrical grid.

Advantageously, the BESS can be arranged to respond instantly to a demand for electricity from the electrical grid. During drawdown of the battery charge, the electricity generating means of the first energy storage means can be engaged and brought on-line until it meets the demand from the grid, allowing the battery to cease discharge. Having both the electricity generating means of the first energy storage means and the BESS connected to a DC bus, which in turn is connected to a single output inverter, permits a practically instantaneous response.

A further advantage of the arrangement is that the BESS does not require separate control; it acts simply to regulate the DC bus connected to the first energy storage means.

It is preferred that the first energy storage means is a pumped hydraulic system. The associated electricity generating means may be a water-powered turbine, or may be a reversible pump.

In a preferred embodiment of the present invention, the pumped hydraulic system is arranged to move water between two reservoirs which may be spaced apart in the order of one to two kilometres, with one raised in relation to the other. In this embodiment a reversible pump may be engaged to produce electricity at a rate in the order of 1.5 megawatts at 690 volts. It will be appreciated that a plurality of pumps may be used in order to increase the electrical output.

The electricity generating means associated with the first energy storage means is preferably arranged to produce alternating current. It is preferred that the DC bus is connected to an inlet inverter, the inlet inverter being arranged to convert AC electricity from the first energy storage means to DC electricity.

The BESS is preferably connected to the DC bus by means of a DC/DC converter. The DC/DC converter may act to regulate the voltage of the DC bus.

In a preferred embodiment the DC bus is in the order of (nominal) 1500 volts, with the output inverter arranged to supply alternating current at 690 volts, delivering power at about 1850 kW.

It will be appreciated that a transformer may be positioned between the output inverter and the broader electrical grid to step-up the voltage to match that of relevant transmission lines.

In a preferred embodiment the BESS is rated at about 1200 kW for a period of time in the order of 10 minutes.

It is preferred that the connection of the electricity generating means of the first energy storage means and the BESS to the wider electrical grid is governed by droop control of both voltage and frequency. It is particularly preferred that this connection is governed by a form of compensated droop control, where the “zero-crossing setpoint” (that is, the setpoint at which the stored energy supply curve intersects the grid supply at zero power output) is variable.

The zero-crossing setpoint is preferably controlled based on a required load placed by the electrical grid on to the stored energy supply.

The droop setting is preferably constant. In a preferred embodiment, the droop setting is 2%.

Preferably, the energy storage and supply system includes a controller which stores a first set of setpoints and at least one second set of setpoints, whereby the first set of setpoints control a current operation of the energy storage and supply system and the second set of setpoints represent the required control in the event of a particular contingency. The controller may have a plurality of second sets of setpoints, each second set of setpoints corresponding to a respective contingency.

The first and second sets of setpoints may include setpoints representing the frequency of AC supplied, the voltage of AC current supplied, a zero-crossing setpoint for frequency, a zero-crossing setpoint for voltage, a fault current contribution setting, a PV runback adjustment, generation shedding settings, and/or load shedding settings.

It is preferred that the controller regularly updates the values of the first and second sets of setpoints based on operating conditions.

According to a second aspect of the present invention there is provided a method of supplying stored electricity, the method including the steps of:
recognising a demand for stored electricity to be supplied;
providing electricity from a battery energy storage system for a first time period;
commencing electricity generation from a first energy storage means during the first time period; and
providing electricity from the first energy storage means during a second time period.

The method is arranged to be performed using the apparatus of the first aspect of the present invention.

The first time period is preferably in the range of 1 to 10 minutes.

The second time period may be up to 24 hours.

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is a general schematic drawing of the present invention;

FIG. 2 is a closer view of a portion of the schematic of FIG. 1;

FIG. 3 is a graph showing operation of compensated droop for frequency where the energy storage and supply system of the present invention is connected to a wider electrical grid;

FIG. 4 is a graph showing operation of compensated droop for frequency where the energy storage and supply system of the present invention is disconnected from a wider electrical grid.

### DETAILED DESCRIPTION OF PREFERRED EMBODIMENTS

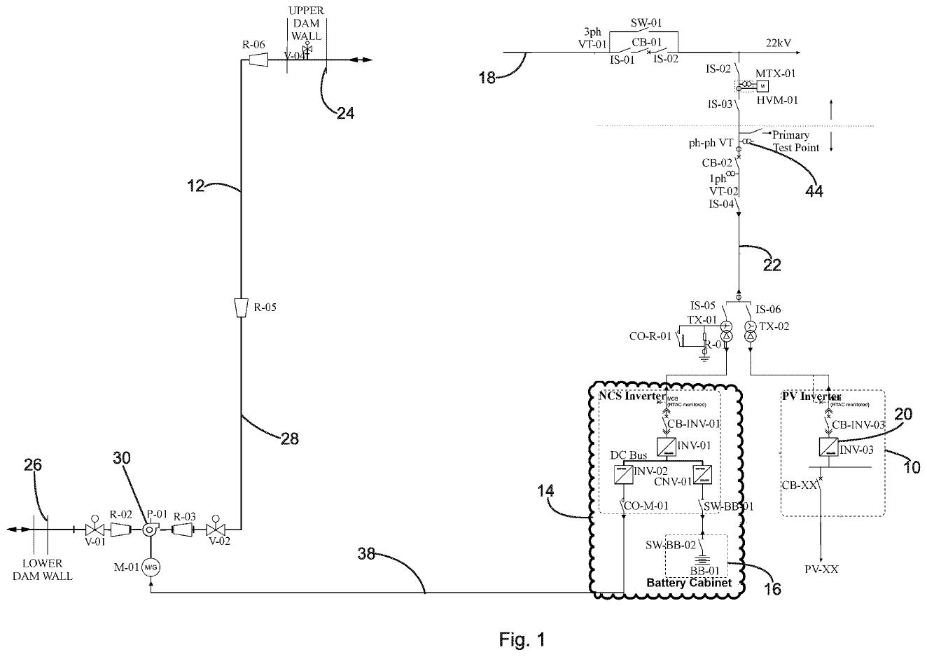

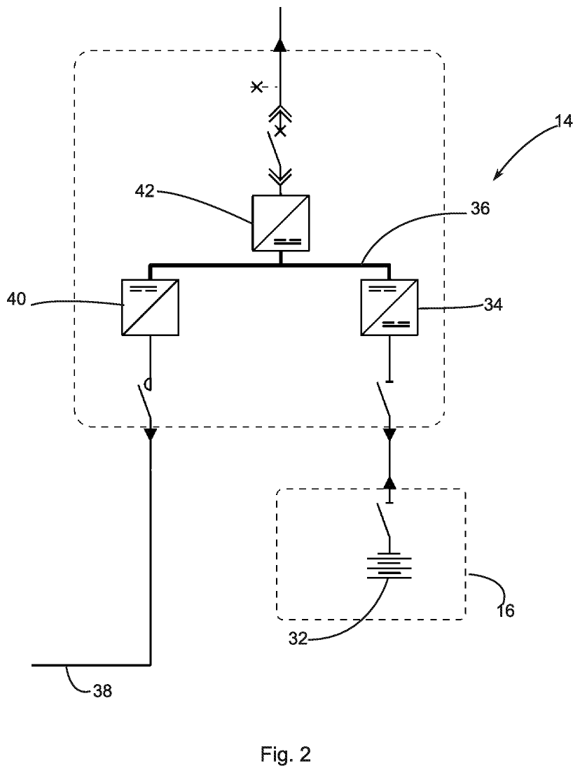

FIGS. 1 and 2 show a particular arrangement of the present invention, currently being designed for installation in a particular location in regional Western Australia.

The system of FIGS. 1 and 2 has four primary elements: a photovoltaic (PV) array and associated controller 10, a pumped hydro energy storage system 12, an electrical control system 14 including a battery energy storage system (BESS) 16, and a transmission line 18 connected to an external electricity grid.

The controller 10 of the PV array includes an inverter 20, arranged to supply alternating current to an output line 22. In the preferred embodiment, the controller 10 of the PV array is also configured to enable fault current contribution from the PV inverter at all times, subject to being called upon.

The pumped hydro energy storage system 12 includes an upper dam 24, a lower dam 26, and a connecting penstock 28. In the embodiment shown each of the upper dam 24 and the lower dam 26 have a capacity in the order of 170 megalitres, with the penstock 28 having a length of about one kilometre. The upper dam 24 is 100 metres above the lower dam 26.

A reversible pump 30 is located along the penstock 28. The reversible pump 30 is arranged to be powered by the PV array in order to pump water from the lower dam 26 to the upper dam 24. The reversible pump 30 is also arranged (in reverse) to generate alternating current at 690 volts, 1.5 megawatt from the flow of water from the upper dam 24 to the lower dam 26. The reversible pump 30 may also be powered by the external electricity grid in circumstances where this is desirable.

The total storage capacity of the system is in the order of 30 megawatt hours. It will be appreciated that this represents about 20 hours of electricity production at maximum operating capacity.

The electrical control system 14 is shown in detail in FIG. 2.

The BESS 16 incorporates at least one battery rack 32 such as the Kokam battery rack model KRI-3C4R-C-240S-HP-150. This represents a total capacity of 150 kWh, with the ability to deliver 900 kW for up to ten minutes. In the system of the drawings two such battery racks 32 are employed, with a combined capacity of 300 kWh and rated for 1200 kW delivery.

The BESS 16 is connected to a DC/DC converter 34. The DC/DC converter 34 is arranged to convert DC current from the BESS 16 at a voltage of 883V to a voltage of 1500V. This is supplied to a common DC bus 36. It will be understood that the DC/DC converter acts to regulate the voltage of the common DC bus 36.

The pumped hydro energy storage system 12 is connected via an electrical cable 38 to an inlet inverter 40. The inlet inverter 40 is arranged to convert AC power from the reversible pump 30 to 1500V DC power. The DC side of the inlet inverter 40 is connected to the common DC bus 36.

The common DC bus 36 is connected at an outlet to a grid inverter 42, arranged to convert the 1500V DC power of the common DC bus 36 to a 690V AC current for connection to the output line 22.

A transformer 44 sits between the output line 22 and the transmission line 18. In the particular embodiment shown, the transformer is arranged to step the voltage up to the 22 kV carried by the transmission line 18.

Key control features of the system described include the constant monitoring of demand of the electrical grid, and constant synchronisation of the grid inverter 42 with the transmission line 18.

In the event that the electrical grid demands stored power from the system, a controller acts to instantaneously supply power from the grid inverter 42, which is taken in turn from the common DC bus 36. In response to this demand for power, the DC/DC converter 34 acts to supply power from the BESS 16 to the common DC bus 36 in order to maintain the common DC bus 36 in equilibrium. In this respect, the BESS 16 acts as an uninterruptable power supply.

The activation of the BESS 16 triggers the reversible pump 30 to begin generating electricity from the pumped hydro energy storage system 12. It is anticipated that the reversible pump 30 can be brought up to full generating capacity within minutes; that is, well within the drawdown time of the BESS 16. Generating electricity from the pumped hydro energy storage system 12 may occur in either of two modes; i) if the demand is within the preferred capabilities of the reversible pump 30 then the reversible pump 30 will operate continuously matched approximately to the demand; or ii) if the demand is less than the preferred capabilities of the reversible pump 30 then the reversible pump 30 will operate intermittently within its preferred capabilities so that its average output is matched approximately to the demand. At any particular moment the BESS 16 will balance the demand.

Once sufficient electricity is being drawn from the reversible pump 30 the BESS 16 can be brought back to a desired state of charge (for instance, 80%).

It will be appreciated that the control system may be operated to supplement and/or replace power being supplied directly by the PV array. The control system acts to smooth transitions. This enables instant and “bumpless” transition to assist in improving the grid reliability, to provide stability and power quality during contingencies/faults; to allow smooth transitioning between steady state import-neutral-export operating modes, and to smooth fluctuations from intermittent renewable generation.

Connection of the grid inverter 42 to the transmission line 18 is controlled using a compensated droop control of both frequency and voltage.

In the system shown, the frequency drop is set at 2%. In a system operating at a nominal 50 Hz, this is equivalent to a 1.0 Hz drop in frequency between zero active power output and maximum output.

The compensation is applied by control of the zero-crossing setpoint. An algorithm within the controller considers the demand being placed on the system, and controls the zero-crossing setpoint accordingly.

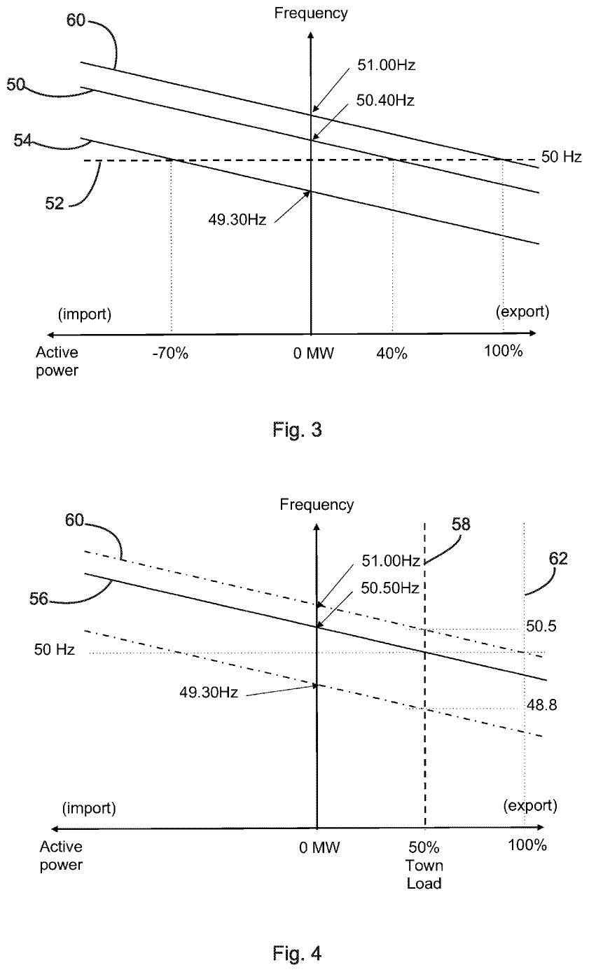

When the system is connected to the wider electrical grid, the grid is dominant and controls the frequency (typically at 50 Hz). FIG. 3 shows the operation of the frequency zero-crossing algorithm in this situation. Where the electrical demand on the storage system is, for instance, 40% of the maximum system output, the zero-crossing setpoint is set to 50.40 Hz so that the droop curve 50 intersects the 50.00 Hz frequency curve 52 at the desired 40% export.

Alternatively, where the electrical demand changed such that the storage system was about to import electrical energy at, for instance, 70% of the storage facility maximum then the zero-crossing setpoint will be set to 49.30 Hz so that the droop curve 54 intersects the 50.00 Hz frequency curve 52 at the desired 70% import.

When the system is disconnected from the wider grid, the frequency of electrical supply is determined by the storage system. In this situation the algorithm acts to change the zero-crossing setpoint based on the instantaneous electrical demand at a given moment in order to achieve a desired frequency of 50.00 Hz. FIG. 4 shows the operation of the frequency zero-crossing algorithm in this situation. Where the electrical demand on the storage system is, for instance, 50% of the maximum system output, the zero-crossing setpoint is set to 50.50 Hz so that the droop curve 56 intersects the load curve 58 at the target frequency of 50.00 Hz. If the demand was to increase to 100% of the maximum system output, the zero-crossing setpoint will be set to 51.00 Hz so that the droop curve 60 intersects the load curve 62 at 50.00 Hz.

Where there is a transition between connection to the grid and disconnection from the grid, the 2% droop doesn't change, but the algorithm will apply a new zero-crossing setpoint based on the new load. In the event of a failure in the system, and the new zero-crossing setpoint is not applied (for instance, a software glitch or a broken wire) the old setpoint will continue in place, ensuring continued supply of power (albeit at a varying frequency).

This situation is shown as droop curve 60 in FIGS. 3 and 4, showing the situation where the system was exporting power to the grid at 100% power export, with a zero-crossing setpoint of 51.00 Hz. In this scenario the town load is 50% of the output of the storage facility. Where the grid connection is lost, and the zero-crossing setpoint fails to update, the droop curve 60 will intersect with the town load curve 58 at 50.50 Hz. This will trigger a system alarm, indicating that the compensation should be reset manually.

Compensated droop control of voltage operates in the same way.

The system of FIGS. 1 and 2 is being designed for use in the regional Western Australian town of Walpole. The town of Walpole is connected to the broader electrical grid by a single 22 kV transmission line 18, in the order of 125 km in length. The system of FIGS. 1 and 2 is arranged for connection to this transmission line 18 at a point close to the town of Walpole. The arrangement is such that, in normal operation, any excess power generated by the PV array can be supplied into the grid. Alternatively, power can be taken from the grid and stored within the pumped hydro energy storage system 12 and/or the BESS 16.

In the event that there is a disruption to the transmission line 18, disconnecting the town from the broader grid, the town becomes an “islanded microgrid”, with power being supplied at least primarily from the system of FIGS. 1 and 2. It will be appreciated that there may be other sources of power within the town, such as small-scale rooftop solar systems, however the system of FIGS. 1 and 2 acts to control the frequency and voltage within the microgrid.

The system is arranged to continually monitor demand on the system, and to adjust operating parameters based on this demand. Operating parameters include the frequency and voltage zero-crossing setpoints discussed above, whether or not the system is supplying a fault current contribution, and any PV runback adjustment required.

The system of the present invention is also arranged to continually calculate the alternative values of the operating parameters which would be required in the event of disruption to the transmission line 18. The arrangement is such that, in the event of a disruption being detected, the system can immediately adopt the alternative values for the operating parameters. The detection of a disruption may occur before the disruption fully impacts the system, and thus the change to alternative values may prevent all or some of the greater impact of the disruption from occurring.

### Example 1

The system of FIGS. 1 and 2 is importing power from the electrical grid at 1.0 MW and 1.0 power factor. Meanwhile, the town is using power from the electrical grid at 0.5 MW and 0.85 power factor, the power being supplied at 50 Hz and 22.00 kV.

The frequency zero-crossing setpoint is set to 49.33 Hz, the voltage zero-crossing setpoint is set to 22.00 kV, the fault current contribution option is set to ‘off’ and the PV runback adjustment is set to ‘off’.

An alternative set of values is also maintained for the event of a sudden loss of connection to the grid, whereby the system of FIGS. 1 and 2 would immediately stop importing power and instead would be required to provide power to the town at 0.5 MW, 0.85 power factor, 50 Hz and 22.00 kV.

In this situation the alternative values maintained in the system would be a frequency zero-crossing setpoint of 50.33 Hz, a voltage zero-crossing setpoint of 22.09 kV, a fault current contribution option set to ‘on’ and a PV runback adjustment of ‘0.00 Hz’.

### Example 2

The system of FIGS. 1 and 2 is generating power from the PV array and exporting to the electrical grid at 1.5 MW and 1.0 power factor. Meanwhile, the town is using power from the electrical grid at 1.0 MW and 0.90 power factor, the power being supplied at 50 Hz and 22.00 kV.

The frequency zero-crossing setpoint is set to 51.00 Hz, the voltage zero-crossing setpoint is set to 22.00 kV, the fault current contribution option is set to ‘off’ and the PV runback adjustment is set to ‘off’.

An alternative set of values is also maintained for the event of a sudden loss of connection to the grid, whereby the system of FIGS. 1 and 2 would immediately stop exporting power to the grid and instead would be required to provide power to the town at 1.0 MW, 0.90 power factor, 50 Hz and 22.00 kV.

In this situation the alternative values maintained in the system would be a frequency zero-crossing setpoint of 50.66 Hz, a voltage zero-crossing setpoint of 22.14 kV, a fault current contribution option set to ‘on’ and a PV runback adjustment of ‘0.00 Hz’.

### Example 3

The system of FIGS. 1 and 2 has a single alternative set of setpoint values, corresponding to a single expected contingency (disconnection from the wider grid). In alternative embodiments of the invention, it is anticipated that a plurality of contingencies can be expected. In this situation, a corresponding plurality of sets of alternative setpoints may be stored.

In one such example, a system similar to that of FIGS. 1 and 2 is connected to a town X. The town X is connected to the main power grid via two transformers, Tx1 and Tx2, each rated at 1.0 MW. The energy storage system is rated to charge or discharge at up to 1.0 MW. The town also has a separate wind turbine which operates at 0.5 MW, a large single load of 0.4 MW, and two electric vehicle supercharges each rated at 0.15 MW. The town includes commercial and residential loads, as well as rooftop solar generation on residences.

The following table lists an example of how the system might operate, with one table listing a current operation and four alternative scenarios for which alternative setpoints are calculated

| | Current | Contingency | Contingency | Contingency | Contingency |
|---|---|---|---|---|---|
| | operation | 1 | 2 | 3 | 4 |
| Description | Storage facility is | Loss of Tx1 | Loss of Tx1 | Fault at wind | Fault at single load |
| | charging/importing | or Tx2 | and Tx2 | turbine also | also causes loss of |
| | from grid at | Grid remains | Grid is | causes loss of | grid (Tx1 and Tx2), |
| | 0.7 MW and 1.0 | connected | disconnected | grid (Tx1 and | plus EV |
| | power factor | Storage | Storage | Tx2) | supercharger and |
| | The wind turbine | facility | facility forms | Grid is | town loads |
| | is generating at | generating at | microgrid | disconnected | Grid is |
| | 0.4 MW | 0.1 MW to | generating at | Storage facility | disconnected |
| | The single load is | prevent other | 0.85 MW to | forms | Town load reduces |
| | 0.4 MW | Tx | balance other | microgrid | and embedded |
| | The town load is | overloading | items | generating at | rooftop solar |
| | 0.85 MW at 0.85 | and other | | 0.85 MW to | exceeds allowable |
| | power factor | items | | balance town | proportion of load |
| | Two EV chargers | continue | | | Storage facility |
| | at combined | normally | | | forms microgrid to |
| | 0.2 MW | | | | balance town |
| | | | | | remaining load |
| Frequency | 50.00 Hz | 50.00 Hz | 50.00 Hz | 50.00 Hz | 50.00 Hz |
| | (actual | (expected | (target) | (target) | (target) |
| | from grid) | from grid) | | | |
| Local | 22.00 kV | 22.00 kV | 22.00 kV | 22.00 kV | 22.00 kV |
| voltage | (actual | (exp | (target) | (target) | (target) |
| | from grid) | frm grid) | | | |

| | Current | Alternative | Alternative | Alternative | Alternative |
|---|---|---|---|---|---|
| | setpoints | setpoints 1 | setpoints 2 | setpoints 3 | setpoints 4 |
| Frequency | 49.30 Hz | 50.10 Hz | 50.85 Hz | 50.85 Hz | 50.50 Hz |
| zero- | (import at | (export at | (balance at | (balance at | (balance at |
| crossing | 0.7 MW) | 0.1 MW) | 0.85 MW) | 0.85 MW) | 0.5 MW) |
| setpoint | | | | | |
| Voltage zero- | 22.00 kV | 22.00 kV | 22.14 kV | 22.14 kV | 22.09 kV |
| crossing | (nil | (nil | (balance at | (balance at | (balance at |
| setpoint | support) | support) | 0.85 pf) | 0.85 pf) | 0.85 pf) |
| Generation | | No | No | No | Yes |
| shed | | | | | Wind turbine |
| Wind | | | | | |
| turbine | | | | | |
| Load shed | | No | Yes | Yes | No |
| single load | | | EV charge | single load | |
| EV charge | | | (prevent | EV charge | |
| | | | overload) | (prevent | |
| | | | | overload) | |
| Fault current | Off | Off | On | On | On |
| contribution | | | | | |
| PV runback | Off | Off | 0.00 Hz | 0.00 Hz | −0.50 Hz (triggers |
| adjustment | | | | | runback of rooftop |
| | | | | | solar) |

Modifications and variations as would be apparent to a skilled addressee are deemed to be within the scope of the present invention.

What is claimed is:

1. An energy storage and supply system including:
a renewable energy source arranged to generate electricity;
a first energy storage means arranged to receive electrical energy and to convert that energy to mechanical potential energy; and
a battery energy storage system (BESS) arranged to receive and store electrical energy;
wherein the first energy storage means includes an electricity generating means arranged to convert mechanical potential energy to electrical energy;
the electricity generating means of the first energy storage means and the BESS both being connected to a common DC bus;
the DC bus being connected to an output inverter;
the output inverter being arranged to supply AC electricity to an electrical grid.

2. An energy storage and supply system as claimed in claim 1, wherein the first energy storage means is a pumped hydraulic system.

3. An energy storage and supply system as claimed in claim 2, wherein the associated electricity generating means is a water-powered turbine or a reversible pump.

4. An energy storage and supply system as claimed in claim 1, wherein the electricity generating means associated with the first energy storage means is arranged to produce alternating current.

5. An energy storage and supply system as claimed in claim 4, wherein the DC bus is connected to an inlet inverter, the inlet inverter being arranged to convert AC electricity from the first energy storage means to DC electricity.

6. An energy storage and supply system as claimed in claim 1, wherein the BESS is connected to the DC bus by means of a DC/DC converter.

7. An energy storage and supply system as claimed in claim 1, wherein a transformer is positioned between the output inverter and the broader electrical grid to step-up the voltage to match that of relevant transmission lines.

8. An energy storage and supply system as claimed in claim 1, whereby connection of the electricity generating means of the first energy storage means and the BESS to the wider electrical grid is governed by compensated droop control of both voltage and frequency, wherein the zero-crossing setpoint is variable.

9. An energy storage and supply system as claimed in claim 8, wherein the zero-crossing setpoint is controlled based on a required load placed by the electrical grid on to the stored energy supply.

10. An energy storage and supply system as claimed in claim 8, wherein the droop setting is constant.

11. An energy storage and supply system as claimed in claim 1, wherein the energy storage and supply system includes a controller which stores a first set of setpoints and at least one second set of setpoints, whereby the first set of setpoints controls a current operation of the energy storage and supply system and the second set of setpoints represents the required control in the event of a particular contingency.

12. An energy storage and supply system as claimed in claim 11, wherein the controller has a plurality of second sets of setpoints, each second set of setpoints corresponding to a respective contingency.

13. An energy storage and supply system as claimed in claim 11, wherein the first and second sets of setpoints include setpoints taken from the group comprising: the frequency of AC supplied, the voltage of AC current supplied, a zero-crossing setpoint for frequency, a zero-crossing setpoint for voltage, a fault current contribution setting, a PV runback adjustment, generation shedding settings, and/or load shedding settings.

14. An energy storage and supply system as claimed in claim 11, wherein the controller regularly updates the values of the first and second sets of setpoints based on operating conditions.

15. A method of supplying stored electricity, the method including the steps of:
recognising a demand for stored electricity to be supplied;
providing electricity from a battery energy storage system for a first time period;
commencing electricity generation from a first energy storage means during the first time period; and
providing electricity from the first energy storage means during a second time period.

16. A method of supplying stored electricity as claimed in claim 15, wherein the first time period is in the range of 1 to 10 minutes.

17. A method of supplying stored electricity as claimed in claim 15, wherein the second time period is up to 24 hours.
